(19) United States
(12) Patent Application Publication
(10) Pub. No.: US 2022/0105620 A1
(43) Pub. Date: Apr. 7, 2022

(54) Hand Tool

(71) Applicant: Kevin B. Tolbert-Wilson, Houston, TX (US)

(72) Inventor: Kevin B. Tolbert-Wilson, Houston, TX (US)

(21) Appl. No.: 17/165,682

(22) Filed: Feb. 2, 2021

(51) Int. Cl. B25F 1/00; B25B 13/56; B25B 13/48

(52) U.S. Cl. CPC B25F 1/00; B25B 13/48; B25B 13/56

(57) ABSTRACT

One or more specific versions disclosed herein is a tool that may include a chassis, a level or level vial, a handle, magnet(s) for adhering to ferromagnetic workpieces and exterior markings.

### BACKGROUND

### 1. Field of Inventions

The field of this application and any resulting patent is hand tools.

### 2. Description of Related Art

Multiple combination hand tools currently exist on the market. There is no single tool that offers a combination of a wrench or wrenches, a level, a ruler, provision to accept sockets/socket adapters, a magnet or magnets and multiple interfaces for the assembly of various attachments including, but not limited to, a handle (fixed and non/rotating). The architecture of this product is unique in that it solves many of the problems that prior art methods and structures have not addressed while having applications across many different fields. The methods, structure and architecture described by the claims below have advantages and benefits that would be novel, surprising and useful to a hypothetical person of ordinary skill with knowledge of the prior art existing at the time of the filing of this application.

### SUMMARY

The disclosure herein is a tool that may include the functions of a wrench, level, crank handle and magnet for adhering to ferromagnetic workpieces.

### DETAILED DESCRIPTION

### 1. Introduction

A detailed description will now be provided. The purpose of this detailed description, which includes the drawings, is to satisfy the statutory requirements of 35 U.S.C. 112. For example, the detailed description includes a description of the inventions defined by the claims and sufficient information that would enable a person having ordinary skill in the art to make and use the inventions. In the figures, like elements are generally indicated by like reference numerals regardless of the view or figure in which the elements appear. The figures are intended to assist the description and to provide a visual representation of certain aspects of the subject matter described herein. The figures are not all necessarily drawn to scale, nor do they show all the structural details of the systems, nor do they limit the scope of the claims.*

Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions and examples, but the inventions are not limited to these specific embodiments, versions or examples, which are included to enable a person having ordinary skill in the art to make and use the inventions when the information in this patent is combined with available information and technology. Various terms as used herein are defined below, and the definitions should be adopted when construing the claims that include those terms, except to the extent a different meaning is given within the specification or in express representations to the Patent and Trademark Office (PTO). To the extent a term used in a claim is not defined below or in representations to the PTO, it should be given the broadest definition persons having skill in the art have given that term as reflected in at least one printed publication, dictionary or issued patent*

*NOTE: Sections (0009), (0010), (0049), (0050) and (0051) are excerpts from the detailed description of U.S. Pat. No. 10,766,123 B1, another patent by the inventor. Firm: Elliott & Polasek, PLLC, Attorneys: Mr. Douglas H. Elliott and Mr. Nathan Q. Huynh*

### 2. BRIEF DESCRIPTION OF THE DRAWINGS

FIG. 1: ISOMETRIC VIEW of an exemplary tool

FIG. 2: ISOMETRIC VIEW of an exemplary chassis

FIG. 3: ISOMETRIC VIEW (alternate) of an exemplary chassis

FIG. 4: TOP VIEW of an exemplary tool

FIG. 5: FRONT VIEW of an exemplary tool

FIG. 6: BOTTOM VIEW of an exemplary tool

FIG. 7: REAR VIEW of an exemplary tool

FIG. 8: LEFT VIEW of an exemplary tool

FIG. 9: RIGHT VIEW of an exemplary tool

FIG. 10: EXPLODED VIEW of an exemplary tool

FIG. 11: DETAIL VIEW of alternate embodiment indicating example placement of a ruler/measuring reference along an edge

FIG. 12: DETAIL VIEW (In situ) of engagement with ¾″ hex drive (standard vise) for adjustment/opening/closing

FIG. 13: DETAIL VIEW (In Situ) of engagement ⅝″ hex drive (standard vise) for adjustment/opening/closing

FIG. 14: DETAIL VIEW (In Situ) of engagement with 9/16″ hex drive (standard vise) for adjustment/opening/closing

FIG. 15: DETAIL VIEW (In Situ) of engagement with ER20 collet toolholder during assembly/disassembly

FIG. 16: DETAIL VIEW (In Situ) of engagement with ER16 collet toolholder during assembly/disassembly

FIG. 17: DETAIL VIEW (In Situ) of engagement with ER11 collet toolholder during assembly/disassembly

FIG. 18: DETAIL VIEW (In Situ) of engagement with ER8 collet toolholder during assembly/disassembly

FIG. 19: DETAIL VIEW of engagement with ⅞″ hex drive

FIG. 20: DETAIL VIEW of socket adapter assembled in tool

FIG. 21: DETAIL VIEW (In Situ) of typical arrangement using socket adapter+socket for assembly/disassembly of a pull stud/retention knob.

FIG. 22: TOP VIEW of 2nd exemplary embodiment (M2T)

FIG. 23: BOTTOM VIEW of 2nd exemplary embodiment (M2T)

FIG. 24: FRONT VIEW of 2nd exemplary embodiment (M2T)

FIG. 25: LEFT VIEW of 2nd exemplary embodiment (M2T)

FIG. 26: RIGHT VIEW of 2nd exemplary embodiment (M2T)

FIG. 27: DETAIL VIEW (In situ—2nd exemplary embodiment (M2T)) of engagement with ¾″ hex drive (standard vise) for adjustment/opening/closing

FIG. 28: DETAIL VIEW (In situ—2nd exemplary embodiment (M2T)) of engagement with ⅝″ hex drive (standard vise) for adjustment/opening/closing

FIG. 29: DETAIL VIEW (In situ—2nd exemplary embodiment (M2T)) of engagement with 9/16″ hex drive (standard vise) for adjustment/opening/closing

FIG. 30: DETAIL VIEW (In situ—2nd exemplary embodiment (M2T)) of engagement with ⅞″ hex drive (standard vise) for adjustment/opening/closing

FIG. 31: DETAIL VIEW (In Situ—2nd exemplary embodiment (M2T)) of engagement with ER16 collet toolholder during assembly/disassembly

FIG. 32: DETAIL VIEW (In Situ—2nd exemplary embodiment (M2T)) of engagement with ER20 collet toolholder during assembly/disassembly

FIG. 33: DETAIL VIEW (In Situ—2nd exemplary embodiment (M2T)) of engagement with ER11 collet toolholder during assembly/disassembly

FIG. 34: PERSPECTIVE VIEW of 3rd exemplary embodiment

FIG. 35: PERSPECTIVE VIEW (alternate) of 3rd exemplary embodiment

FIG. 36: PERSPECTIVE VIEW of 4th exemplary embodiment

FIG. 37: PERSPECTIVE VIEW (alternate) 4th exemplary embodiment

FIG. 38: PERSPECTIVE VIEW of 5th exemplary embodiment

FIG. 39: PERSPECTIVE VIEW (alternate) of 5th exemplary embodiment

FIG. 40: PERSPECTIVE VIEW of 6th exemplary embodiment

FIG. 41: PERSPECTIVE VIEW (alternate) of 6th exemplary embodiment

FIG. 42: TOP VIEW of 7th exemplary embodiment

FIG. 43: BOTTOM VIEW (alternate) of 7th exemplary embodiment

### 3. SELECTED DEFINITIONS

The term “aperture” as used herein is defined as any opening in a solid object or structure. For example, an aperture may be an opening that begins on one side of the solid object and ends on the other side of the object. An aperture may alternatively be an opening that does not pass entirely through the object, but only partially passes through, e.g. as a groove. An aperture can be an opening in an object that is completely circumscribed, defined, or delimited by the object itself. Alternatively, an aperture can be an opening in the object when the object is combined with one or more objects or structures. One or more apertures may be disposed and passed entirely though a chassis, base, handle, bearing, washer and spacer. An aperture may receive another object and permit ingress and/or egress of the object through the aperture.*

The term “chassis” as used herein refers to the load bearing framework of an artificial or manufactured object which structurally supports the object in its construction and function and serves as a platform for the mounting of other components or structures.*

The term “threaded” as used herein is defined as having threads. Threads may include one or more helical protrusions or grooves on a surface of a cylindrical object. Each full rotation of a protrusion or groove around a threaded surface of the object is referred to herein as a single “thread.” A bolt may include a “threaded portion” wherein a section of the bolt includes threads. A threaded portion may be threadably mated with a “box thread” disposed in a chassis, base or handle.*

### 4. SPECIFIC EMBODIMENTS OF THE DRAWINGS

The drawings presented do not limit the scope of the claims in any way and are designed to enable one having ordinary skill in the art to make and use the claimed invention(s). Although this section covers the drawings herein and the specific embodiments found in those drawings, parts of this section may be applicable to other embodiments not described in the drawings.

Various changes, substitutions, alterations, iterations and modifications can be made to the embodiments described herein without departing from the scope and spirit of the invention as defined in the claims below. The preferred embodiments can be studied and other means identified to practice the invention that are not exactly as described in this application.

Described herein is a tool that may be comprised of the following elements:

Element One (Chassis): This is the base structure of the device. It may contain an open end wrench or wrenches, a closed end wrench or wrenches, or a combination of open end and closed end wrenches. It may also contain a threaded, non-threaded or a combination of threaded and non-threaded aperture(s) for the installation, integration, assembly, attachment or joining of other components such as a level(s) or level vial(s), magnet(s) or a handle(s).

Element Two (Level): This may be an assembly containing a level or a level vial by itself.

Element Three (Magnets): Magnet(s) may be assembled into the chassis for the purpose of securing the device to a ferromagnetic surface or workpiece.

Element Four (Screws): Mechanical fasteners may be employed to securely affix the level to Element One.

Element Five (Inserts): Threaded inserts may be installed in the chassis to facilitate the installation of handles or other attachments of use.

Element Six (Set Screws): Set screws or other devices may be installed to protect threads/inserts from damage when not in use.

Element Seven: Exterior markings (etching, engraving, etc. . . . ) may be applied to the tool to facilitate reference measurement (Ruler).

A total of 7 exemplary embodiments are presented here to help demonstrate the range of possible configurations for this invention.

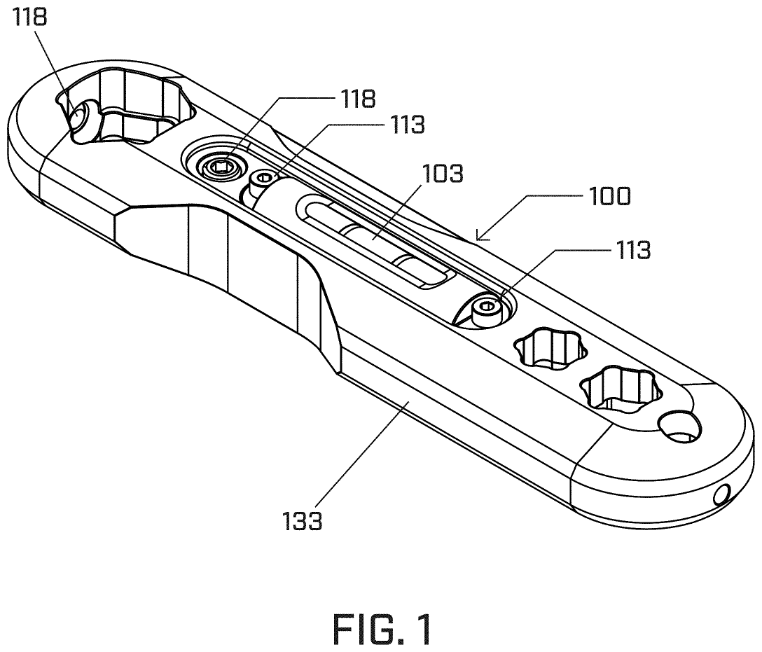

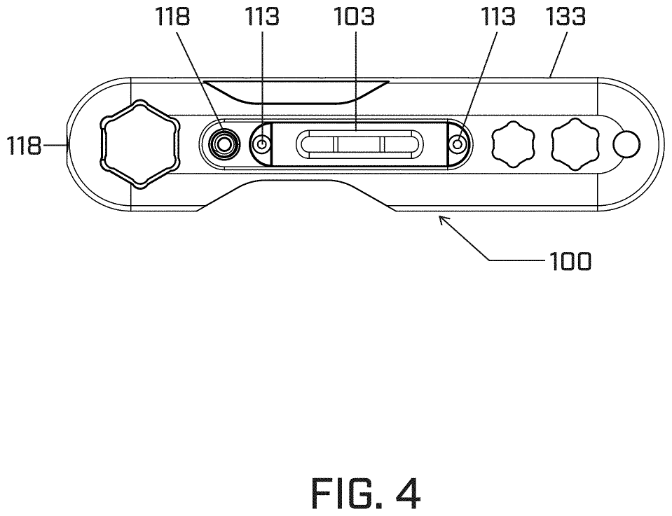

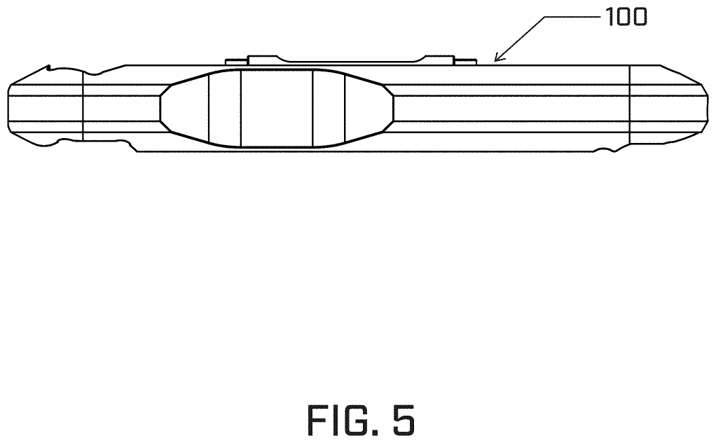

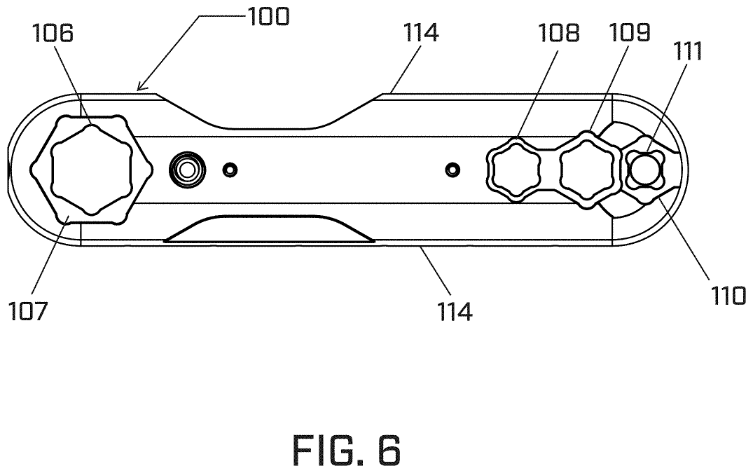

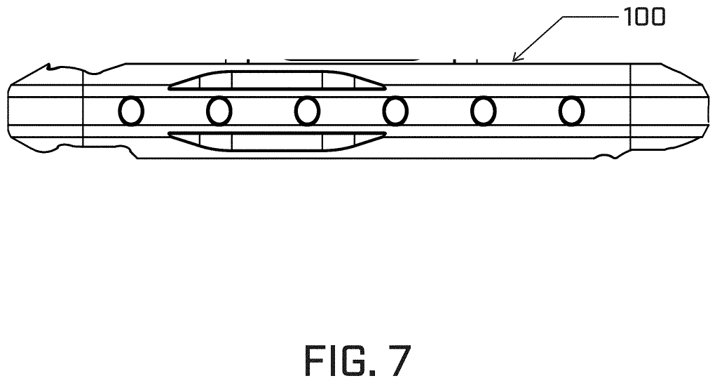

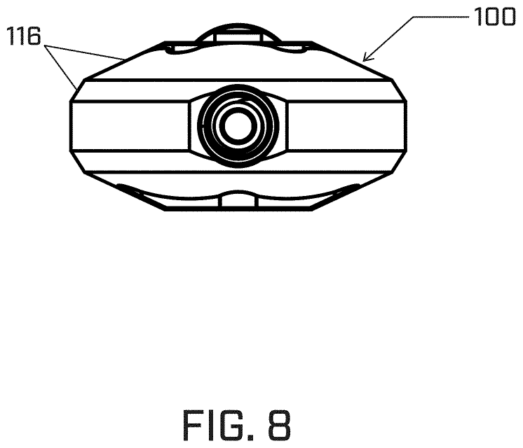

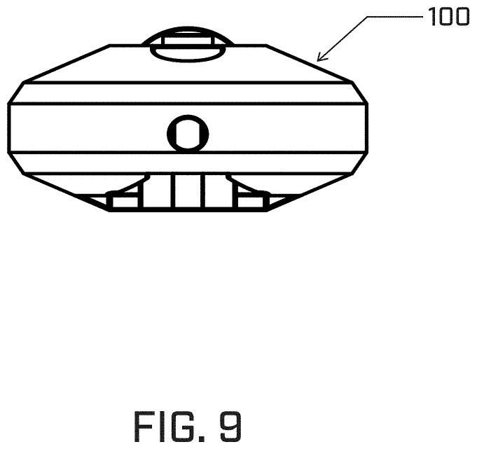

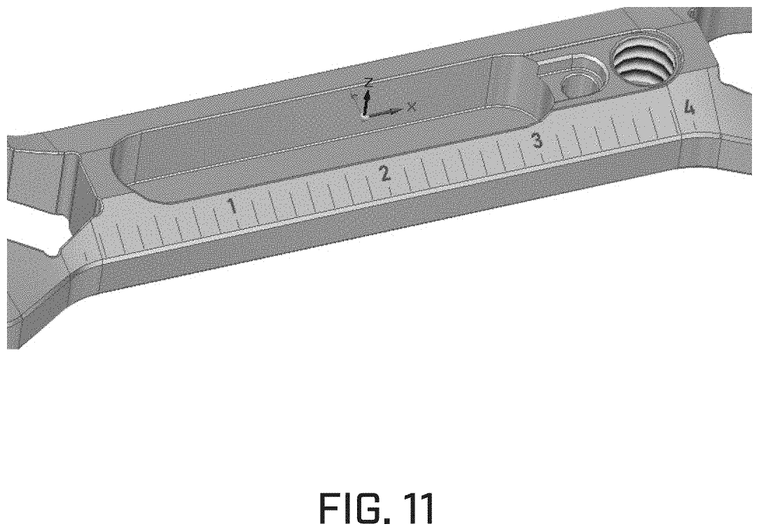

FIGS. 1-21 refer to the 1st exemplary embodiment of the invention.

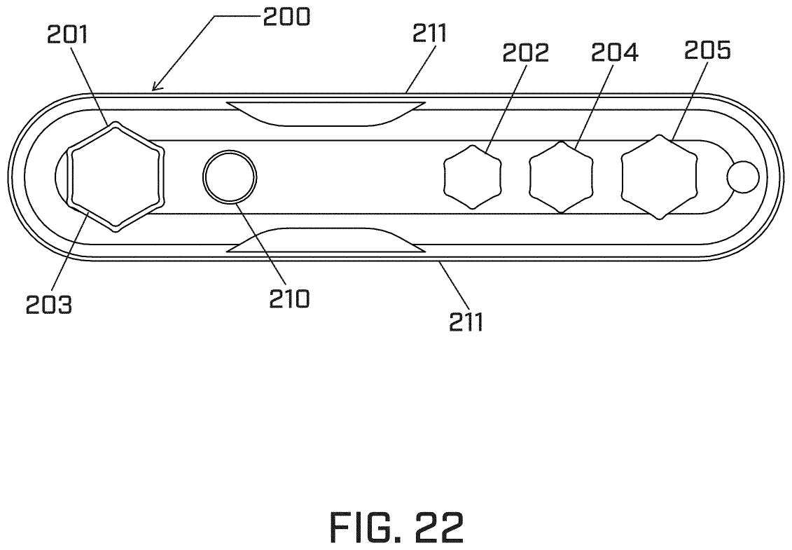

FIGS. 22-33 refer to the 2nd exemplary embodiment of the invention.

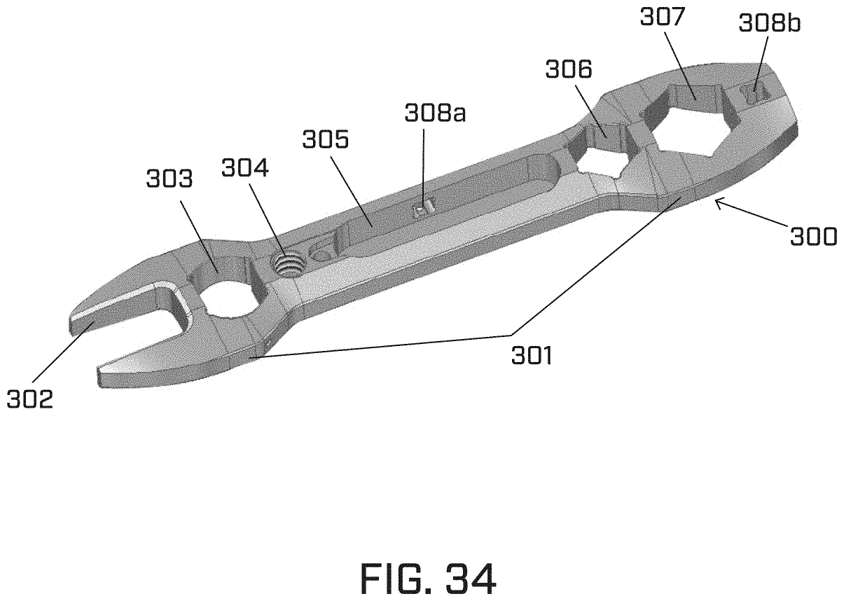

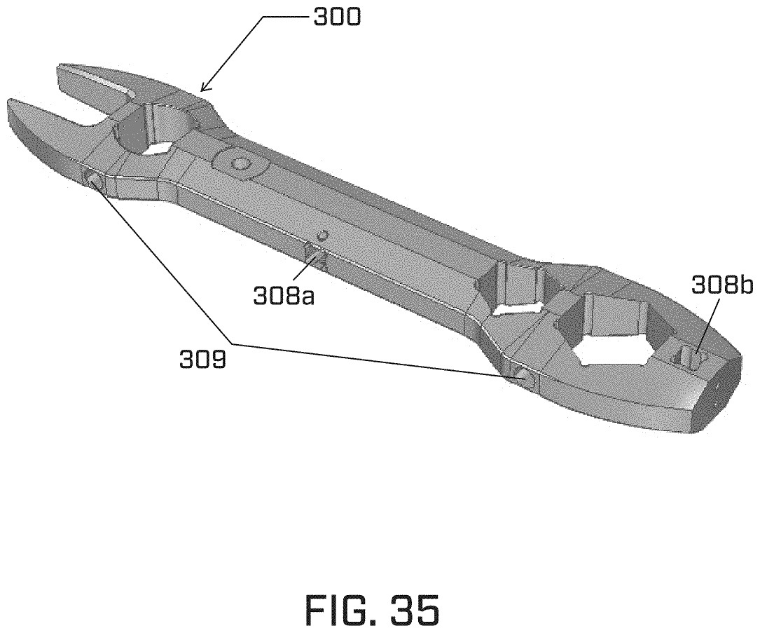

FIGS. 34-35 refer to the 3rd exemplary embodiment of the invention.

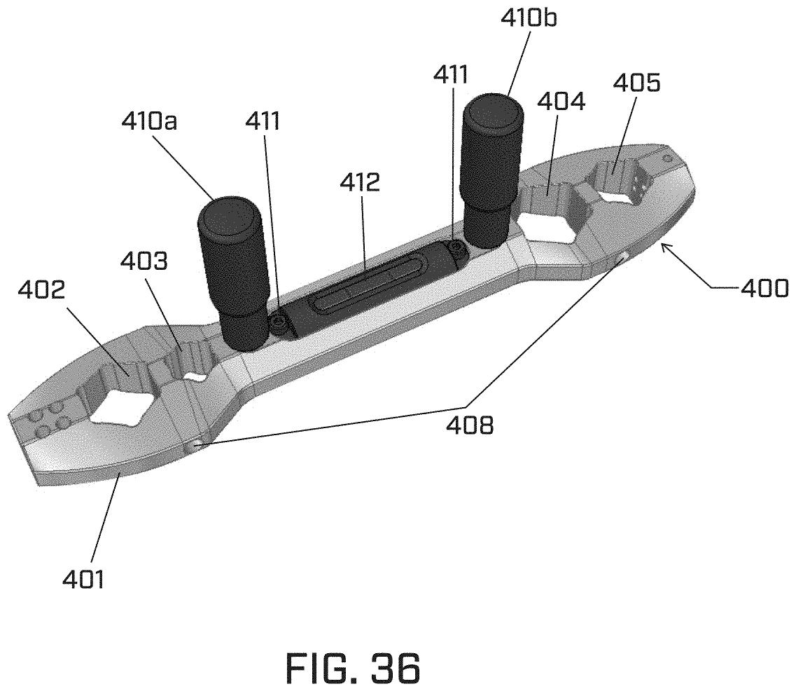

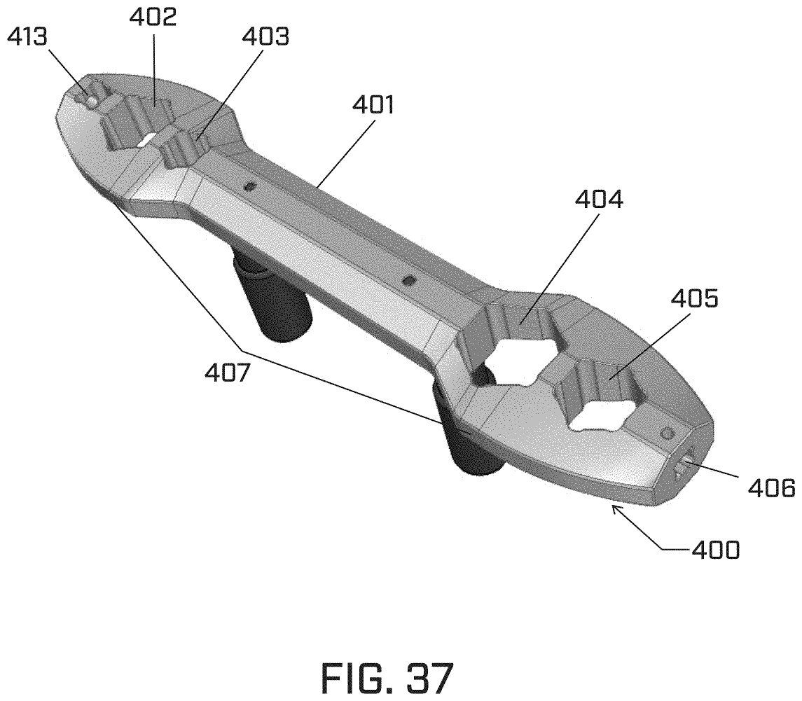

FIGS. 36-37 refer to the 4th exemplary embodiment of the invention.

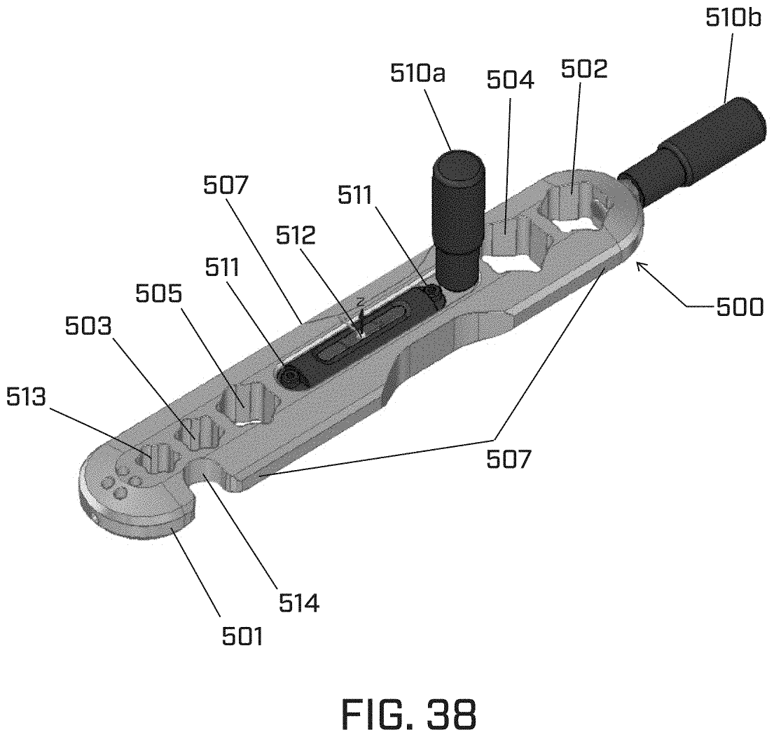

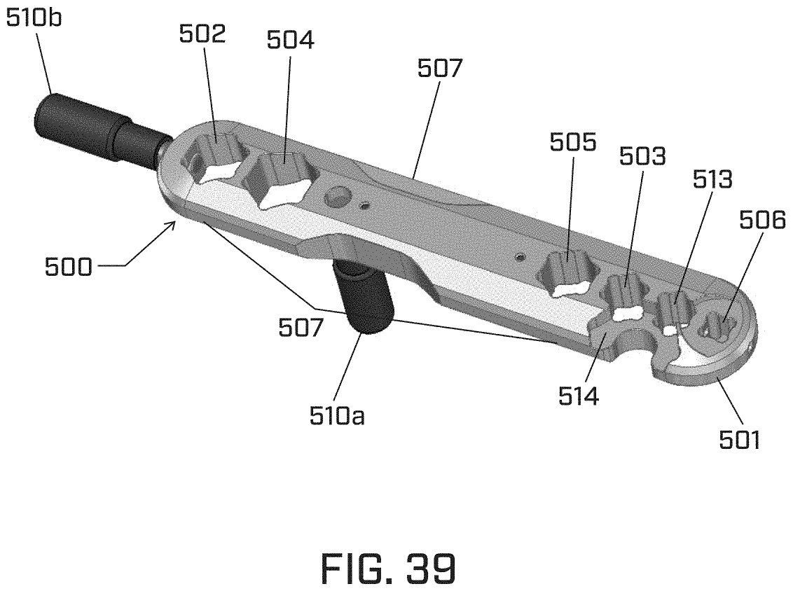

FIGS. 38-39 refer to the 5th exemplary embodiment of the invention.

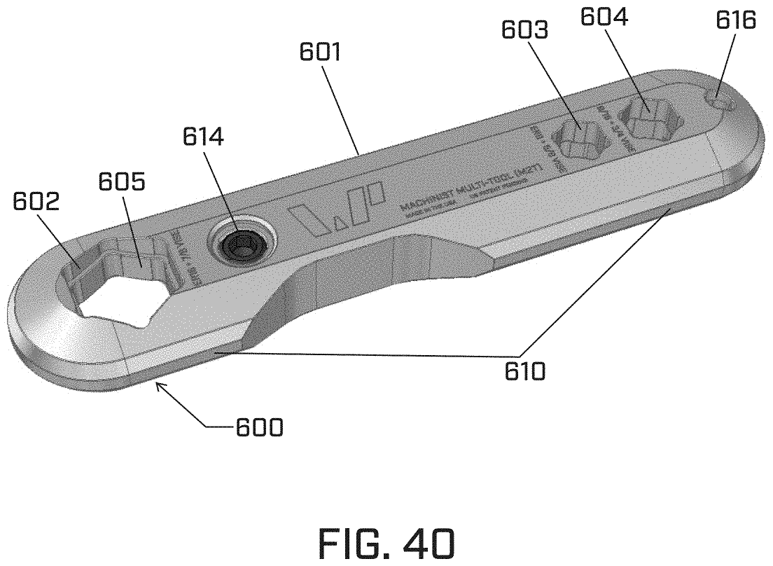

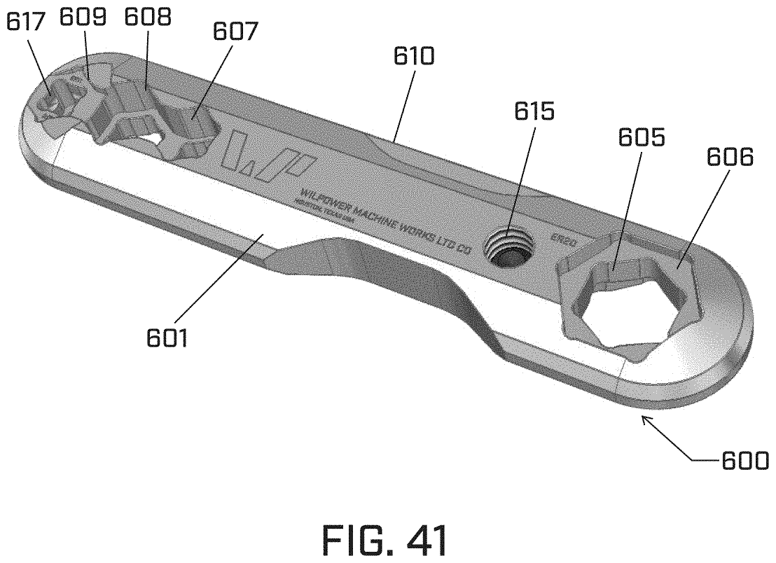

FIGS. 40-41 refer to the 6th exemplary embodiment of the invention.

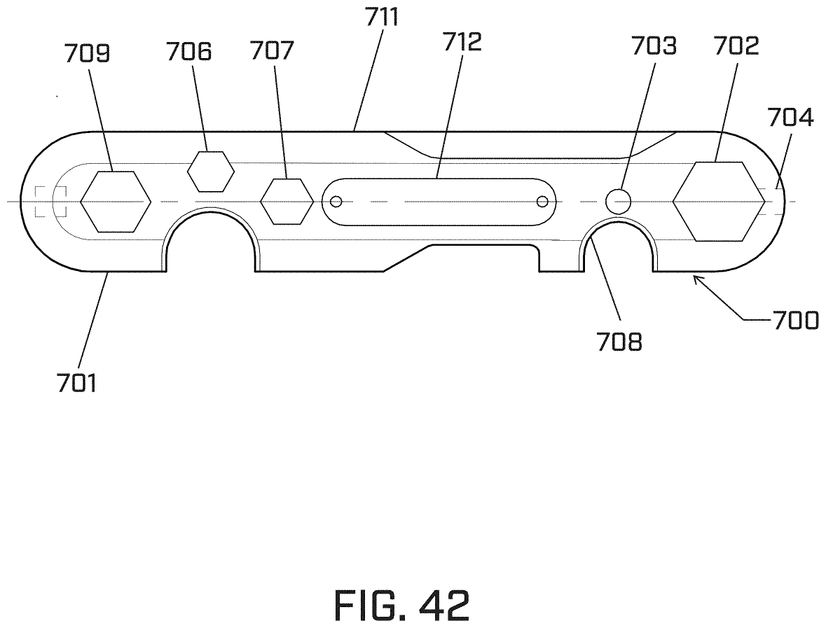

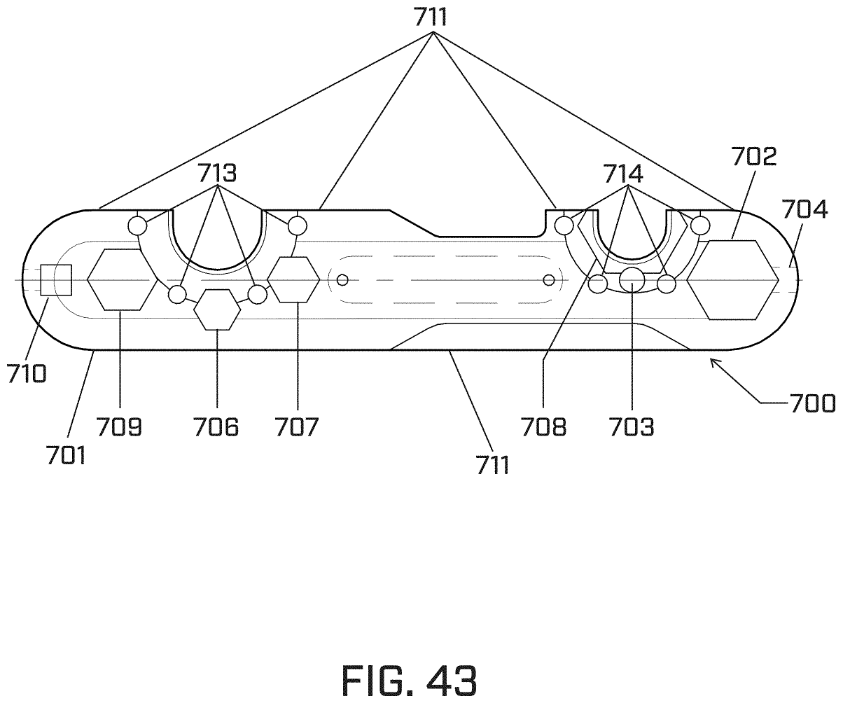

FIGS. 42-43 refer to the 7th exemplary embodiment of the invention.

It should be noted that while the exemplary embodiments contain hexagonal or square drive wrenches, the invention can accommodate other types including pentagonal, external torx and 8 or 12-point screw drives.

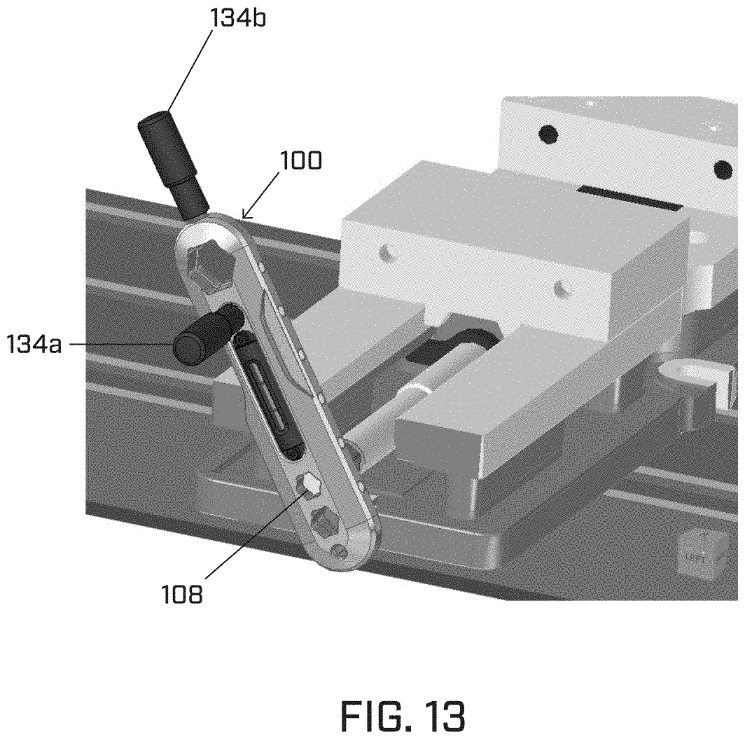

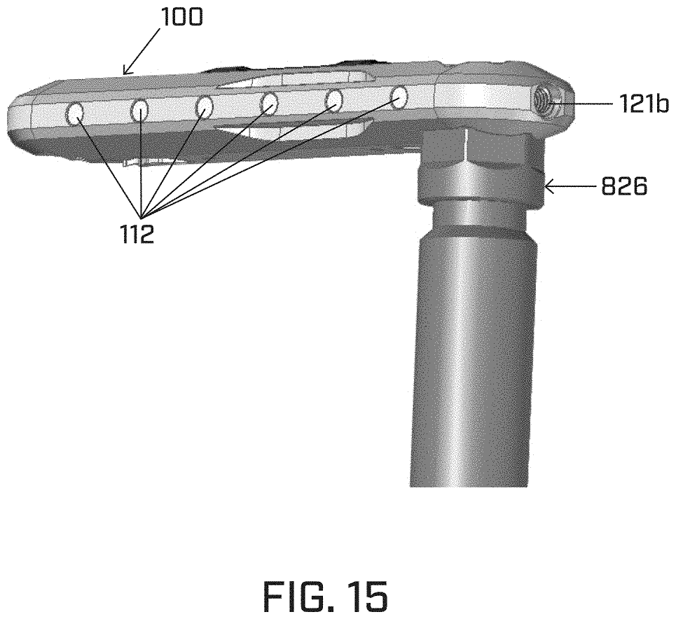

FIG. 1 illustrates an ISOMETRIC VIEW of an exemplary tool 100. The tool 100 may include a chassis 133, a level or level vial 103, magnet(s) (See FIG. 15) 112, fasteners 113 and a handle(s) (See FIG. 13) 134a or 134b.

FIG. 13 illustrates the exemplary tool 100 in use with two installed handles 134a and 134b.

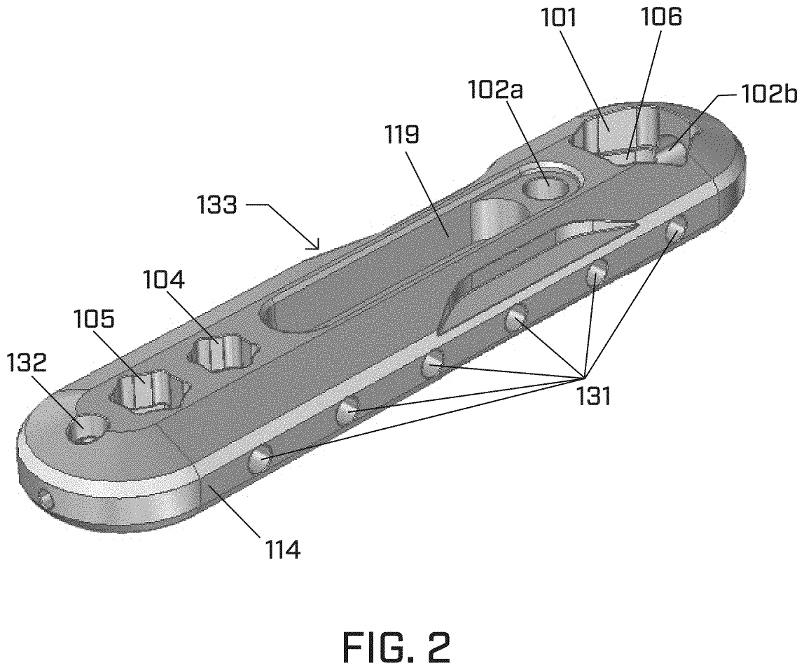

FIG. 2 illustrates an ISOMETRIC VIEW of the chassis 133 of the exemplary tool 100. The chassis may contain aperture(s) 131 for magnets, an aperture 119 for a level, apertures (threaded or non) 102a and 102b to receive inserts, a handle or other component, a 9/16″ wrench 104, an ER8 collet wrench 105, an ER16 collet wrench 101, and a ⅞″ wrench 106.

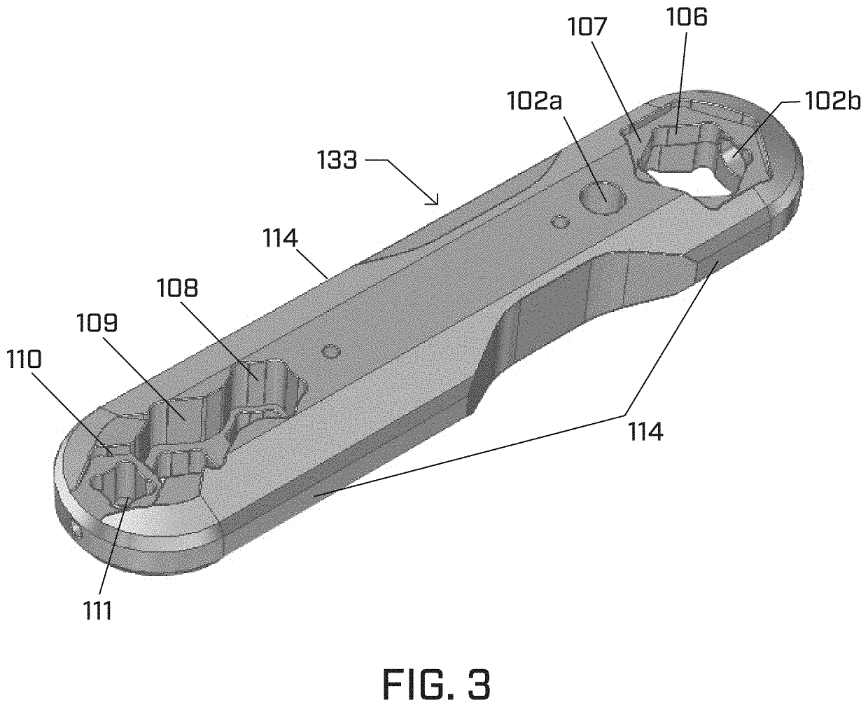

FIG. 3 illustrates an alternate ISOMETRIC VIEW of the chassis 133 of the exemplary tool 100. The chassis may also contain an ER11 wrench 110, a ⅜″ wrench 111, a ¾″ wrench 109, a ⅝″ wrench 108, an ER20 collet wrench 107 and flat surfaces 114 along the perimeter of the chassis.

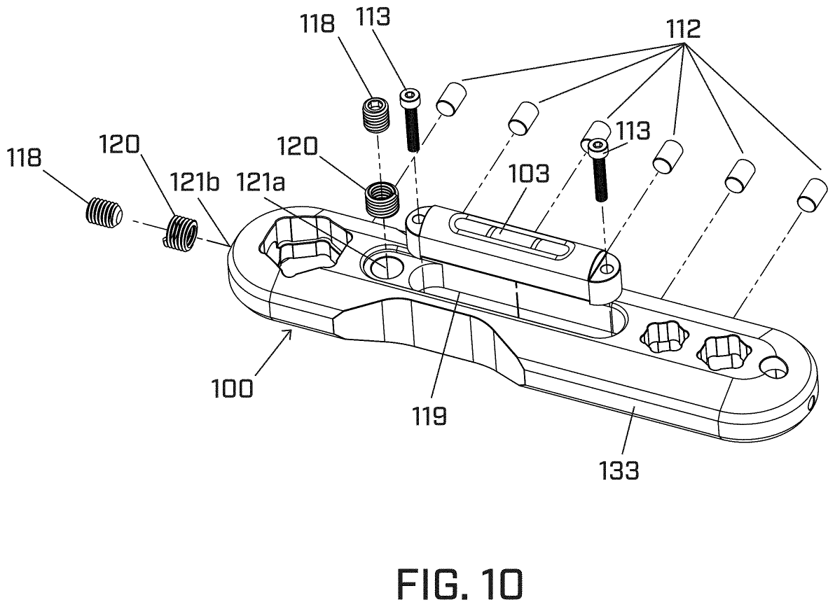

FIG. 10 illustrates an EXPLODED VIEW of the exemplary tool 100. Magnets may be disposed in magnet aperture(s) (See FIG. 2) 131. A level or level vial 103 may be disposed in the level aperture 119. The level may be attached to the chassis with fasteners 113. The fasteners may be mechanical, adhesive, or tape. Components could also be joined via sonic or frictional welding or other means. The level or level vial 103 may also be molded or printed in. Inserts 120 or set screws 118 may be disposed in apertures 121a and 121b.

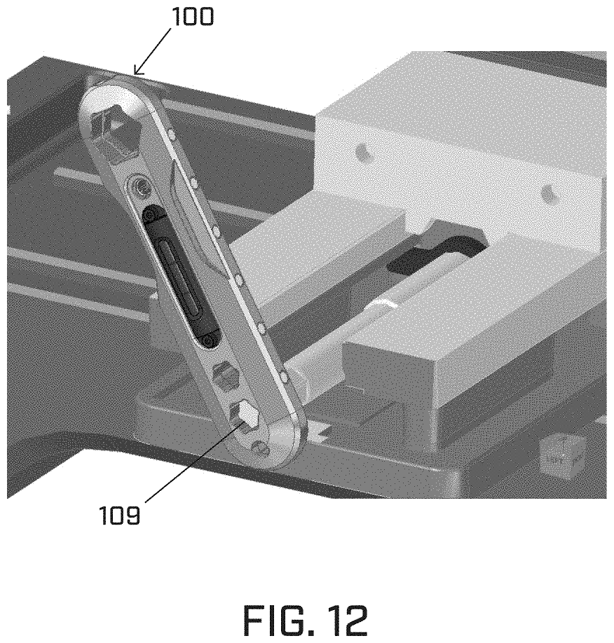

FIG. 12 illustrates the exemplary tool 100 being used as a ¾″ wrench 109.

FIG. 13 illustrates the exemplary tool 100 being used as a ⅝″ wrench 108.

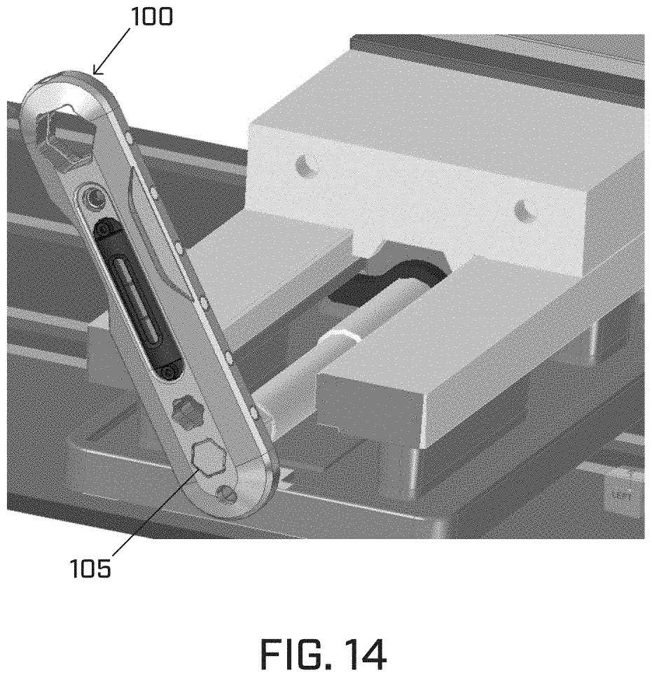

FIG. 14 illustrates the exemplary tool 100 being used as a 9/18″ wrench 105.

FIG. 15 illustrates the exemplary tool 100 being used on an ER20 collet nut 826.

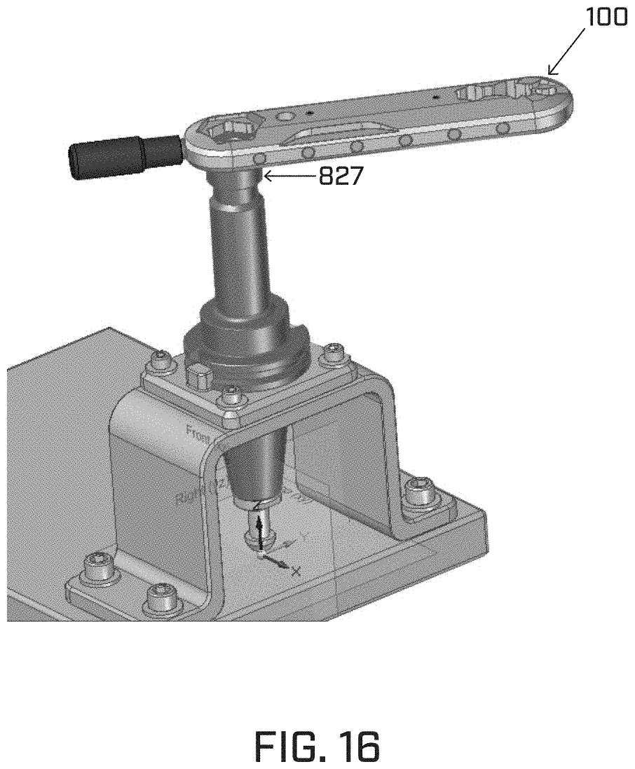

FIG. 16 illustrates the exemplary tool 100 being used on an ER16 collet nut 827.

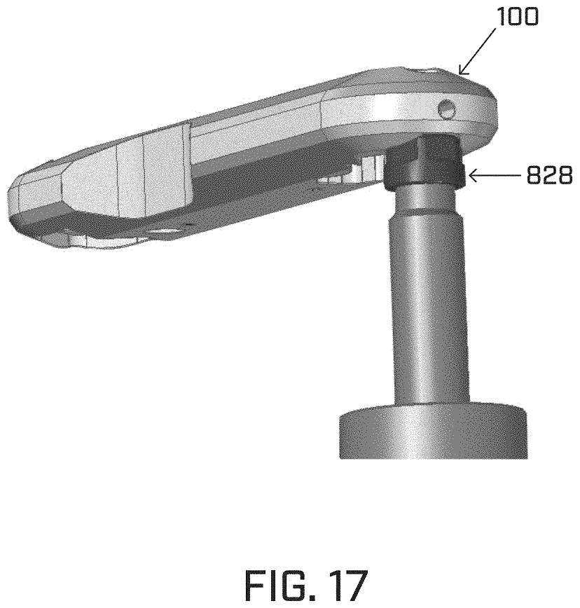

FIG. 17 illustrates the exemplary tool 100 being used on an ER11 collet nut 828.

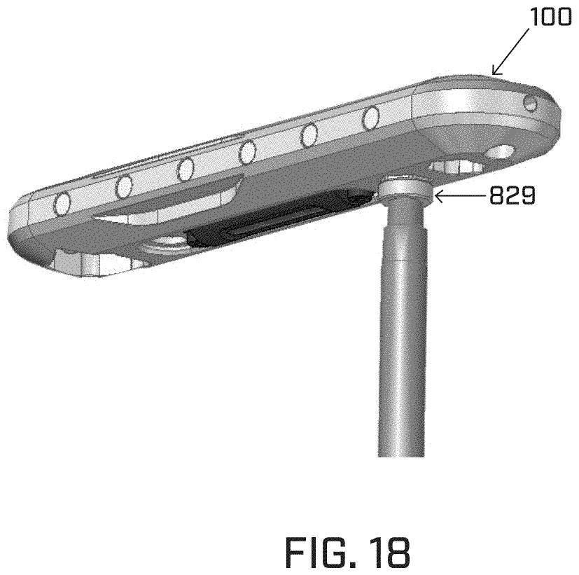

FIG. 18 illustrates the exemplary tool 100 being used on an ER8 collet nut 829.

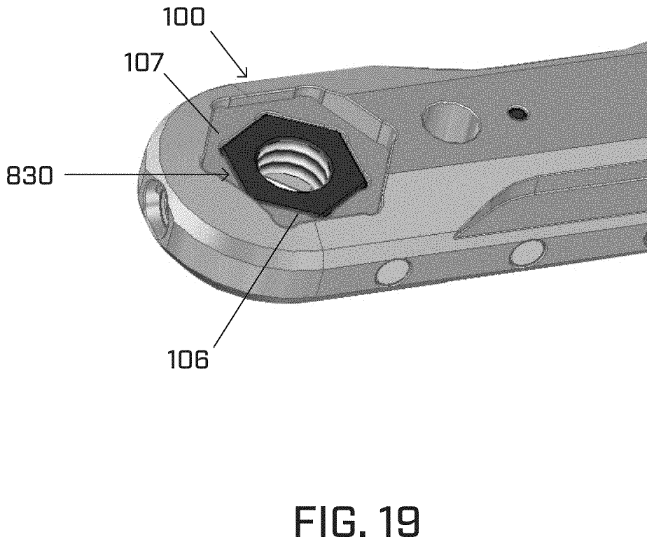

FIG. 19 illustrates the exemplary tool 100 being used on a ⅞″ hex drive 830.

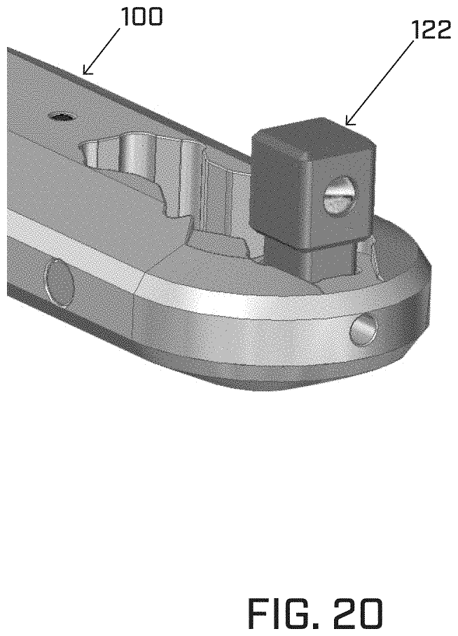

FIG. 20 illustrates the exemplary tool 100 with a square drive adapter 122 disposed in the ⅜″ wrench 111.

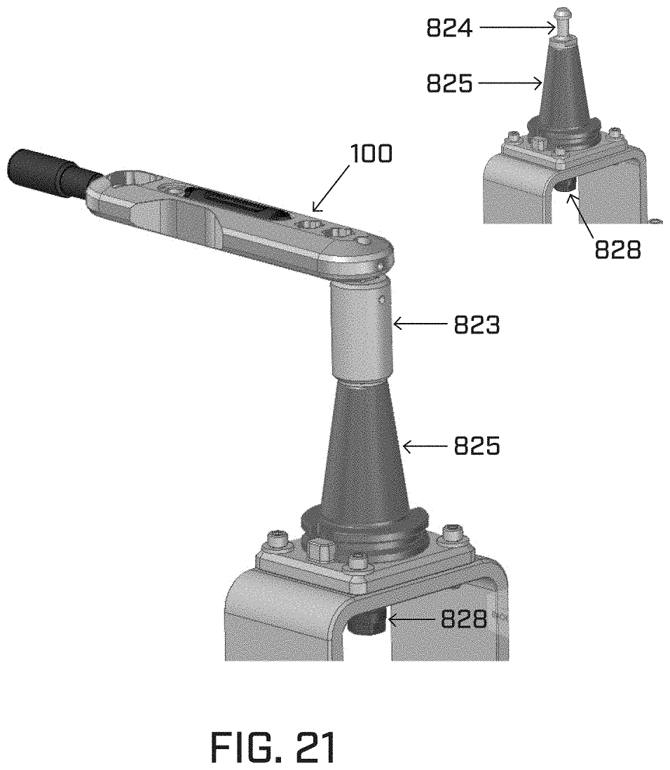

FIG. 21 illustrates the exemplary tool 100 with a pull stud socket 823 installed.

FIG. 22 illustrates a TOP VIEW of an exemplary tool chassis 200 that may contain a ER16 wrench 201, ⅞″ wrench 203, a 9/18″ wrench 202, a ⅝″ wrench 204, a ¾″ wrench 205, an aperture 210 (threaded or non) to accept a handle or other component, and flat surface(s) 211.

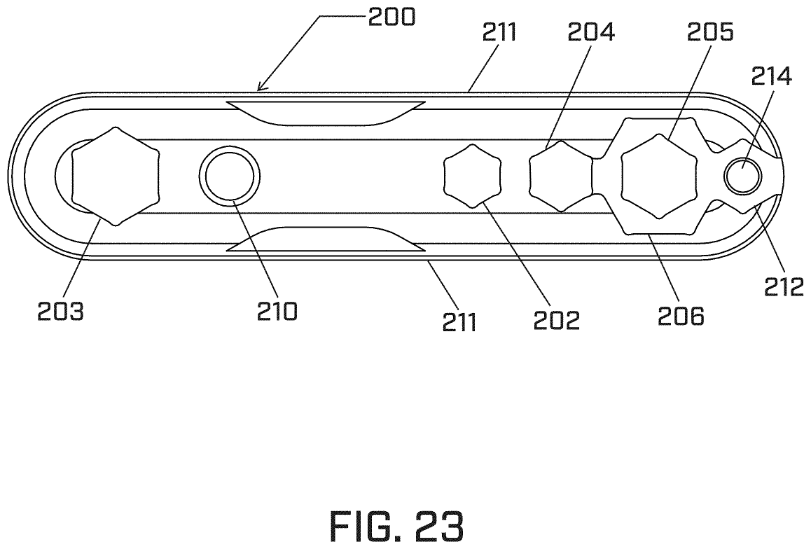

FIG. 23 illustrates a BOTTOM VIEW of the exemplary tool chassis 200 that may also contain an ER20 collet wrench 206, ER11 collet wrench 212 and an aperture 214.

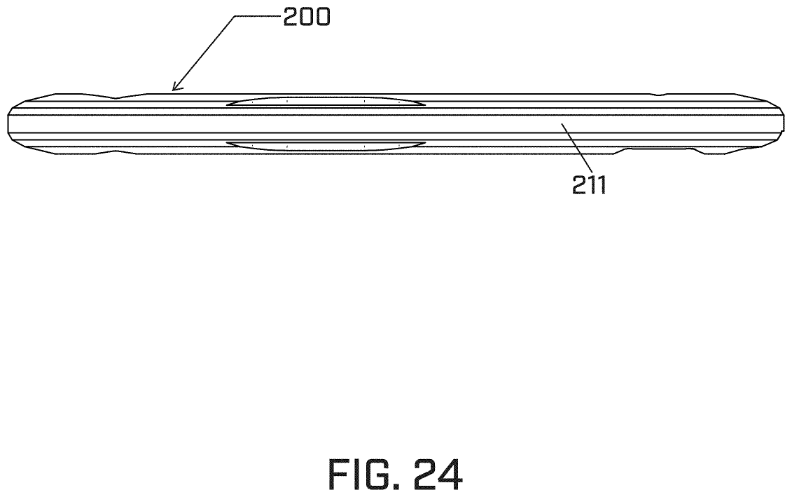

FIG. 24 illustrates a FRONT VIEW of the exemplary tool chassis 200.

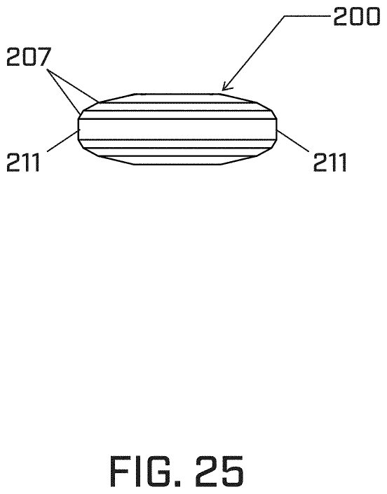

FIG. 25 illustrates a LEFT VIEW of the exemplary chassis 200.

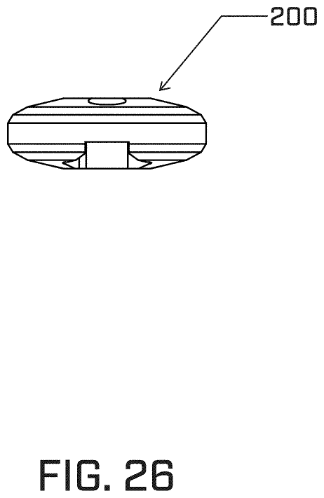

FIG. 26 illustrates a RIGHT VIEW of the exemplary chassis 200.

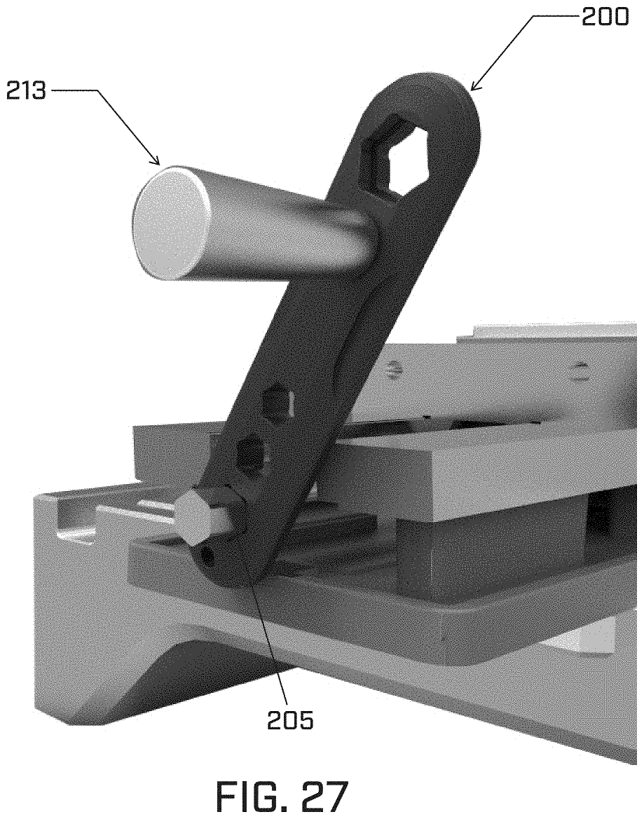

FIG. 27 illustrates the exemplary tool chassis 200 being used as a ¾″ wrench 205. A handle 213 is shown assembled to the chassis.

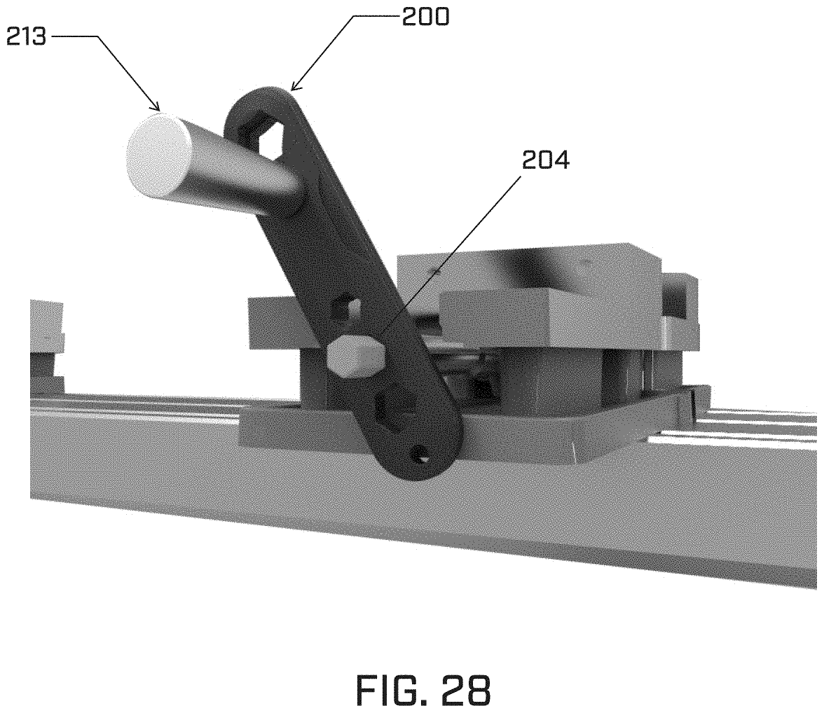

FIG. 28 illustrates the exemplary tool chassis 200 being used as a ⅝″ wrench 204. A handle 213 is shown assembled to the chassis.

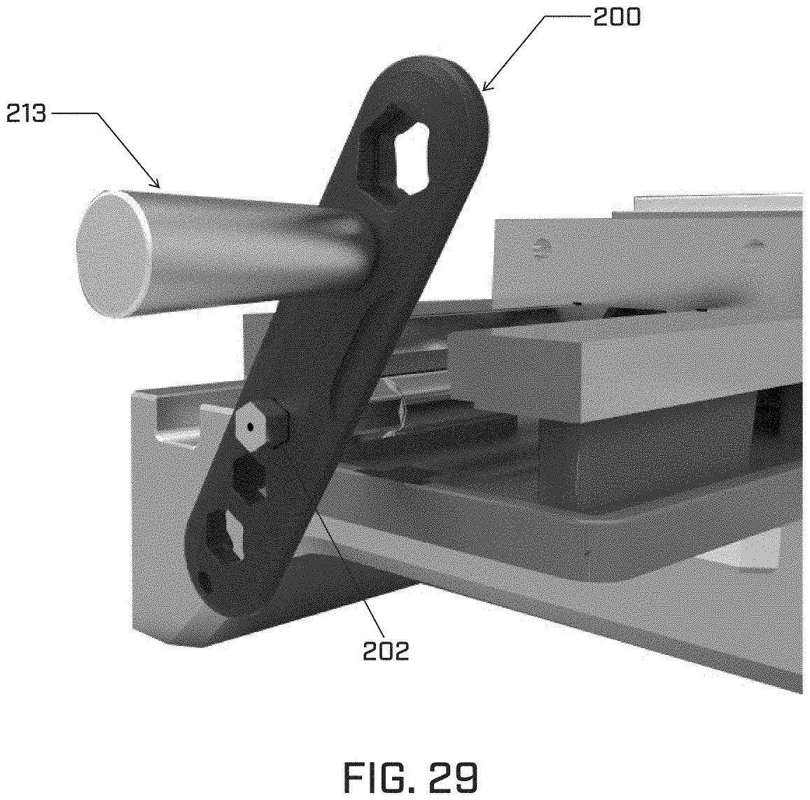

FIG. 29 illustrates the exemplary tool chassis 200 being used as a 9/16″ wrench 202. A handle 213 is shown assembled to the chassis.

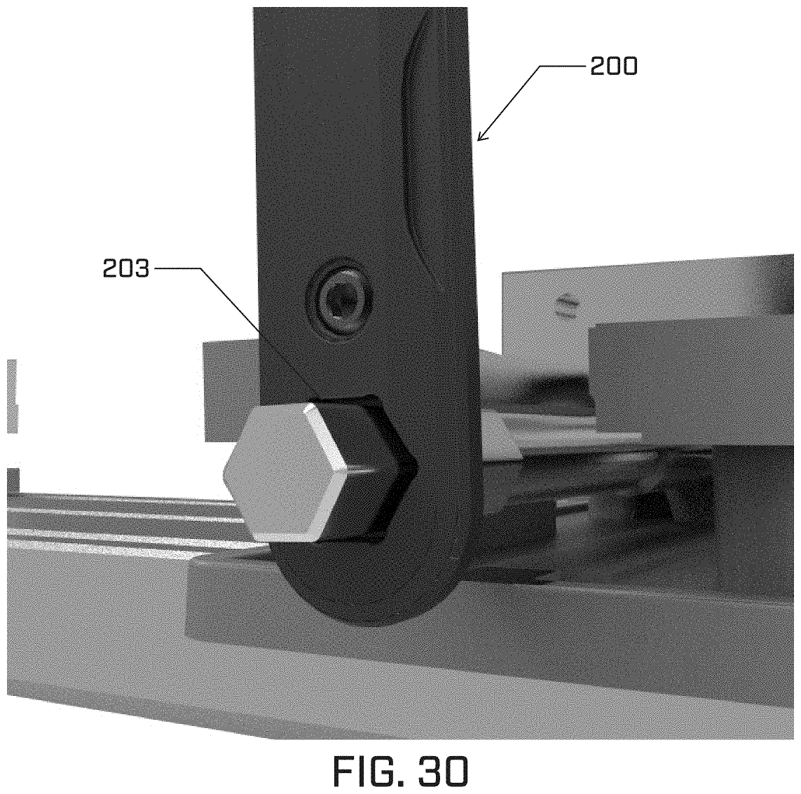

FIG. 30 illustrates the exemplary tool chassis 200 being used as a ⅞″ wrench 203.

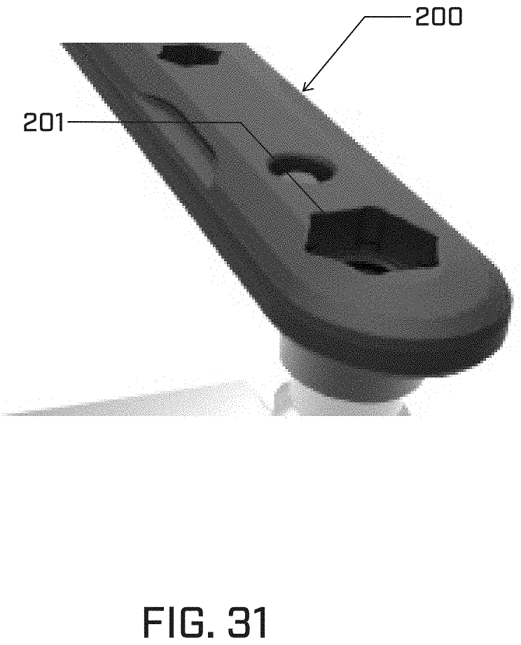

FIG. 31 illustrates the exemplary tool chassis 200 being used as an ER16 wrench 201.

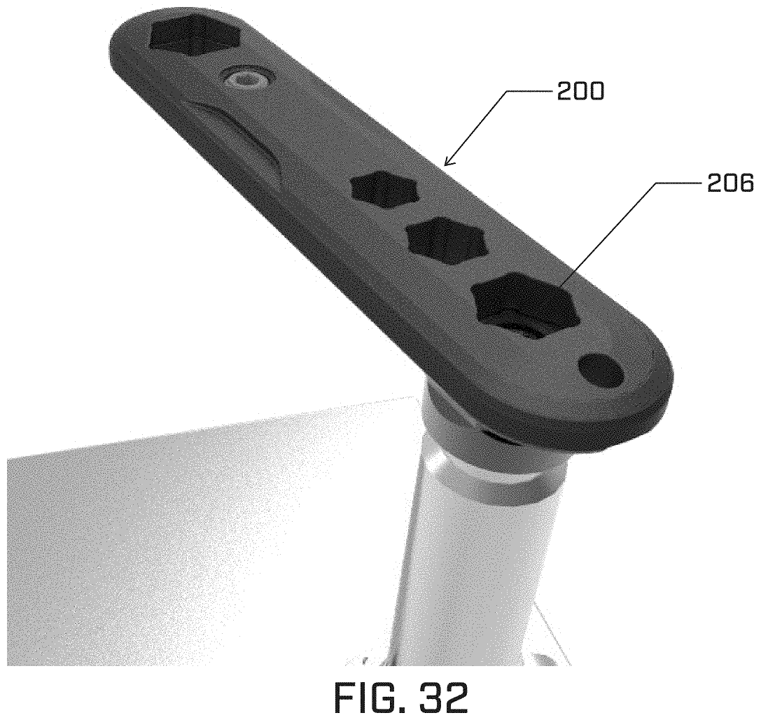

FIG. 32 illustrates the exemplary tool chassis 200 being used as an ER20 wrench 206.

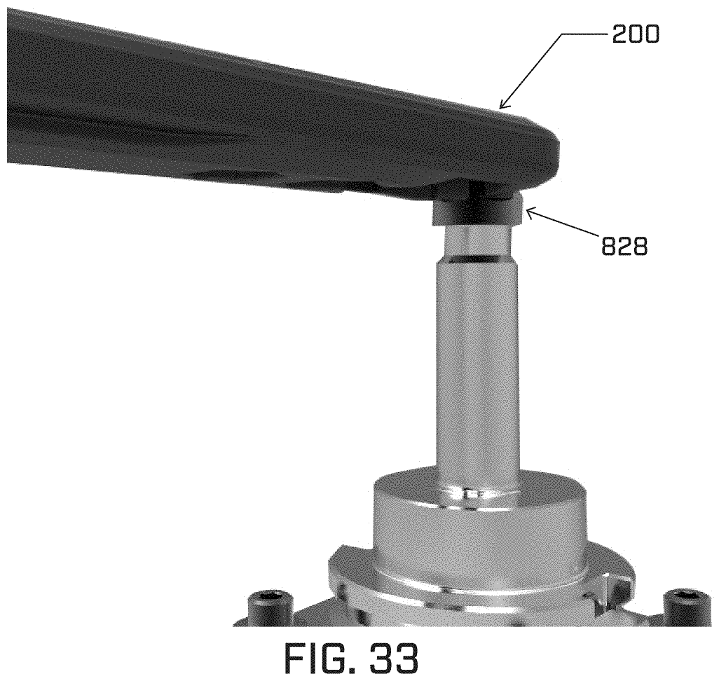

FIG. 33 illustrates the exemplary tool chassis 200 being used on an ER11 collet nut 828.

FIG. 34 illustrates a PERSPECTIVE VIEW of an exemplary tool chassis 300. The chassis 300 may contain a ⅞″ wrench 302, a pull stud wrench 303, an aperture or apertures 304 and 305 (threaded or non), a ¾″ wrench 306, an ER16 wrench 307, a flat surface or surfaces 301, and a ¼″ wrench 308a or 308b.

FIG. 35 illustrates an alternate PERSPECTIVE VIEW of the exemplary tool chassis 300. It may also include aperture(s) 309 for a magnet.

FIG. 36 illustrates a PERSPECTIVE VIEW of an exemplary tool 400. The tool 400 may contain a chassis 401, a level or level vial 412, fasteners 411 and a handle(s) 410a and 410b. The chassis 401 may contain a ⅞″ wrench 402, a 9/16″ wrench 403, an ER16 wrench 404, a ¾″ wrench 405, and aperture(s) 408 for magnet(s).

FIG. 37 illustrates an alternate PERSPECTIVE VIEW of the exemplary tool 400. The tool 400 may also contain a ¼″ wrench 406, a ⅜″ wrench 413 and a flat surface(s) 407.

FIG. 38 illustrates a PERSPECTIVE VIEW of an exemplary tool 500. The tool 500 may contain a chassis 501, a level or level vial 512, fasteners 511 and a handle(s) 510a and 510b. The chassis 501 may contain a ⅞″ wrench 502, a 9/16″ wrench 503, an ER16 wrench 504, a ¾″ wrench 505, an ER8 collet wrench 513, an ER20 collet wrench 514 and a flat surface(s) 507.

FIG. 39 illustrates an alternate PERSPECTIVE VIEW of exemplary tool 500. The tool 500 may also contain a ⅜″ wrench 506.

FIG. 40 illustrates a PERSPECTIVE VIEW of an exemplary tool 600. The tool 600 may include a chassis 601 and a set screw or other means of protecting a thread 614. The chassis 601 may contain an ER16 wrench 602, a ⅞″ wrench 605, an ER8 collet wrench 603, a 9/16″ wrench 604, an aperture 616 and a flat surface(s) 610.

FIG. 41 illustrates an alternate PERSPECTIVE VIEW of the exemplary tool 600. The chassis 601 may also contain a ⅜″ wrench 617, an ER11 collet wrench 609, a ¾″ wrench 608, a ⅝″ wrench 607, and an ER20 wrench 606.

FIG. 42 illustrates a TOP VIEW of an exemplary tool chassis 700. The chassis 700 may contain a ¾″ wrench 709, an ER8 collet wrench 708, an 9/18″ wrench 707, an aperture 712 for a level or other component, an aperture 703 (threaded or non) for a handle or other component, an ER16 wrench 702, an ER20 wrench 708, an aperture 704 (threaded or non) for a handle or other component and a flat surface(s) 711.

FIG. 43 illustrates a bottom view of the exemplary tool chassis 700. The chassis may also contain an ER32 wrench 713 or an ER25 wrench 714.

What is claimed as the invention is:

1) A tool comprising:
a chassis containing an open end wrench or wrenches, a closed end wrench or wrenches, or
a combination of open end and closed end wrenches.

2) The tool of claim 1, further comprising a level(s) or level vial(s).

3) The tool of claim 1, further comprising a handle or handles.

4) The tool of claim 1, further comprising a magnet or magnets for engaging a non-fastener object or objects.

5) The tool of claim 1, wherein the chassis may contain any of the following wrench sizes: 5/32,″ 3/16,″ 7/32,″ ¼,″ 9/32,″ 5/16,″ 11/32,″ ⅜,″ 7/16,″ ½,″ 9/16,″ ⅝,″ 11/16,″ ¾,″ 13/16,″ ⅞,″ 15/16,″ 1,″ 11/16,″ 11/8,″ 3.2 MM, 4 MM, 4.5 MM, 5 MM, 5.5 MM, 6 MM, 6.3 MM, 7 MM, 8 MM, 9 MM, 10 MM, 11 MM, 12 MM, 13 MM, 14 MM, 15 MM, 16 MM, 17 MM, 18 MM, 19 MM, 20 MM, 21 MM, 22 MM, 23 MM, 24 MM, 25 MM, 26 MM, 27 MM, 28 MM, 29 MM, 30 MM, 31 MM, 32 MM, 34 MM, 35 MM, 36 MM, 38 MM, 40 MM, 41 MM, 42 MM, 46 MM, 50 MM, 54 MM, 55 MM, 58 MM, 60 MM, ER25 collet nut, ER32 collet nut, ER40 collet nut, ER50 collet nut, ER8M collet nut, ER11M collet nut, ER16M collet nut, ER20M collet nut, ER25M collet nut, External Torx Size E4, External Torx Size E5, External Torx Size E6, External Torx Size E7, External Torx Size E8, External Torx Size E10, External Torx Size E12, External Torx Size E14, External Torx Size E16, External Torx Size E18, External Torx Size E20, External Torx Size E24, External Torx Size E28, External Torx Size E32, External Torx Size E36, External Torx Size E40, and External Torx Size E44.

6) The tool of claim 1, wherein the chassis may contain a threaded aperture or apertures, a non-threaded aperture or apertures or a combination of threaded and non-threaded aperture(s) for the installation, integration, assembly, attachment or joining of other components.

7) The tool of claim 1, wherein the chassis may have a flat surface(s).
